(19) United States
(12) Patent Application Publication
(10) Pub. No.: US 2013/0213005 A1
(43) Pub. Date: Aug. 22, 2013

(54) SYSTEM AND METHOD FOR ZERO REACTION TIME COMBUSTION

(71) Applicant: Soundblast Technologies, LLC, (US)

(72) Inventor: Larry W. Fullerton, New Hope, AL (US)

(73) Assignee: SOUNDBLAST TECHNOLOGIES, LLC, Winter Park, FL (US)

(21) Appl. No.: 13/763,297

(22) Filed: Feb. 8, 2013

Related U.S. Application Data
(60) Provisional application No. 61/596,468, filed on Feb. 8, 2012.

(51) Int. Cl. F02K 9/95; F23D 14/62; F23Q 3/00; F23D 14/38

(52) U.S. Cl. CPC F02K 9/95; F23D 14/38; F23D 14/62; F23Q 3/008
USPC 60/39.827; 431/157; 431/265; 431/353

(57) ABSTRACT

A system and method for zero reaction time combustion is provided where a gaseous or dispersive fuel-oxidant mixture is supplied to a fill point of a tube having a fill point and an open end. An igniter placed at an ignition point in the tube continuously ignites the gaseous or dispersive fuel-oxidant mixture while the gaseous or dispersive fuel-oxidant mixture is flowing through the tube thereby continuously producing zero reaction time combustion at that ignition point that produces exhaust and a continuous pressure. The exhaust travels from the ignition point to the open end of the tube.

### FIELD OF THE INVENTION

The present invention relates generally to a system and method for zero reaction time combustion. More particularly, the present invention relates to a system and method for zero reaction time combustion where continuous ignition of a gaseous or dispersive fuel-oxidant mixture flowing within a tubular structure generates a constant pressure or thrust.

### BACKGROUND OF THE INVENTION

Many prior art gas detonation systems are based on a deflagration to detonation transition (DDT) process that requires long tubes or highly detonable gas mixtures such as oxygen and hydrogen in order to produce a detonation. Otherwise such systems would only deflagrate which is a slow and nearly silent process. FIG. 1A depicts a side view of a prior art DDT system. A detonation tube 100 has separate fuel supply 102 and oxidizer supply 104 which are opened during a fill period to fill detonation tube 100 with fuel-oxidant mixture 106. After the fill period, fuel supply 102 and oxidizer supply 104 are closed and at a desired time a charge is applied through high voltage wire 108 to spark plug 110, which ignites the fuel-oxidant mixture 106 causing a deflagration to detonation transition that results in a detonation wave that propagates down the length of the detonation tube 100 and exits its open end 112. Similarly, FIG. 1B depicts a side view of another prior art DDT system where detonation tube 100 has a fuel-oxidant mixture supply 105 which is opened during a fill period to fill detonation tube 100 with fuel-oxidant mixture 106. After the fill period, fuel-oxidant mixture supply 105 is closed and at a desired time a charge is applied through high voltage wire 108 to spark plug 110, which ignites the fuel-oxidant mixture 106 causing a deflagration to detonation transition that results in a detonation wave that propagates down the length of the detonation tube 100 and exits its open end 112.

A prior art instantaneous detonation process invented by the present inventor is described in U.S. Pat. No. 7,886,866, which is incorporated herein by reference in its entirety. The process involves passing an electric arc through a flowing (or moving) stream of gas and oxidizer mixture that is filling a tube within which the instantaneous detonation takes place. When the tube is substantially full, a fast spark is initiated within the flowing gas at an ignition point in the tube. A detonation impulse is produced at the ignition point, which is an improvement over previous deflagration to detonation transition (DDT) processes, where detonation occurs at some point downstream of an ignition point. The detonation impulse then triggers the subsequent detonation of all the gas from the location of ignition to an open end of the tube. As such, the instantaneous detonation process enabled precise timing and magnitude control of a detonation impulse, which could then be used to trigger a larger detonation in an adjoining detonation tube such as described in U.S. Pat. No. 7,882,926 and U.S. patent application Ser. No. 11/785,327, filed Apr. 17, 2007, titled “System And Method For Generating And Controlling Conducted Acoustic Waves For Geophysical Exploration”, which are both incorporated by reference herein in their entireties.

FIG. 2A depicts the detonation tube 100 of an overpressure wave generator 11 that uses the instantaneous detonation process being supplied by fuel-oxidant mixture supply 105 via detonator 114, where a spark ignites within the fuel-oxidant mixture 106 while the detonation tube 100 is being filed with the fuel-oxidant mixture 106 instantaneously producing a detonation impulse and causing a detonation wave to propagate down the length of the detonation tube 100 and exit its open end 112. Under one arrangement, an appropriate fuel-oxidant mixture flow rate is maintained during ignition within the flowing fuel-oxidant mixture. It has been found that over a substantial range of flows the higher the flow rate the more rapid the evolution of the detonation wave. Hence, one could use a high flow rate. For a given spark energy, a certain flow rate defines the practical upper limit of flow rate. Under another arrangement, the tubing that feeds the detonation tube is below a critical radius to prevent the detonation progressing back to the fuel-oxidant mixture supply. For example, one embodiment uses ¼″ diameter tubing to prevent such flashback and yet presents a low resistance to gas flow. For example, a 1″ long detonator having a ¼″ diameter bore hole can achieve detonation using a 1 joule spark within a MAPP gas-air mixture flowing at 50 liters/minute.

Also shown in FIG. 2A is an optional secondary fuel-oxidant mixture supply 105′. One or more secondary fuel-oxidant mixture supplies 105′ can be used to speed up the filling of a large detonation tube (or tube combination). With one approach, one or more secondary fuel-oxidant mixture supplies 105′ are used to speed up filling of a detonation tube 100 in parallel with the (primary) fuel-oxidant mixture supply 105 such that detonator 114 can ignite the flowing fuel-oxidant mixture at a desired flow rate. With another approach, fuel-oxidant mixture supply 105 may supply the detonation tube at a first higher rate and then change to a second rate prior to the flowing fuel-oxidant mixture being ignited. In still another approach, secondary fuel-oxidant mixture supply 105′ supplies a different fuel-oxidant mixture 106′ (not shown in FIG. 2A) into detonation tube 100 than the fuel-oxidant mixture 106 supplied by fuel-oxidant mixture supply 105 into detonator 114.

For certain fuels it may be necessary to heat the fuel-oxidant mixture in order to achieve detonation. Depending on the rate at which the detonation tube is fired, it may be necessary to cool the detonation tube. Under one preferred embodiment of the invention, fuel-oxidant mixture supply 105 (and/or 105′) comprises at least one heat exchange apparatus (not shown) in contact with the detonation tube that serves to transfer heat from the detonation tube to the fuel-oxidant mixture. A heat exchange apparatus can take any of various well known forms such as small tubing that spirals around the detonation tube from one end to the other where the tightness of the spiral may be constant or may vary over the length of the detonation tube. Another exemplary heat exchanger approach is for the detonation tube to be encompassed by a containment vessel such that fuel-oxidant mixture within the containment vessel that is in contact with the detonation tube absorbs heat from the detonation tube. Alternatively, a heat exchanger apparatus may be used that is independent of fuel-oxidant mixture supply 105 in which case some substance other than the fuel-oxidant mixture, for example a liquid such as water or silicon, can be used to absorb heat from the detonation tube. Alternatively, another source of heat may be used to heat the fuel-oxidant mixture. Generally, various well known techniques can be used to cool the detonation tube and/or to heat the fuel-oxidant mixture including methods that transfer heat from the detonation tube to the fuel-oxidant mixture.

FIG. 2B depicts an embodiment of the prior art detonator of FIG. 2A that functions by creating an electrical arc within a stream of a detonatable gas mixture. As shown in FIG. 2B, a gas mixture 106 of a combustible gas and oxidizer in the correct detonable ratio is passed into a detonation tube 100 via fill point 208 of detonator 114. When the tube is substantially full, high voltage wire 108 is triggered at high voltage pulse input 214 to cause a spark 212 to occur across bare wires 210 and to pass through the gas mixture 106 flowing into the detonation tube 100 to initiate detonation of the gas in the detonation tube 100. Triggering of high voltage pulse is controlled by control mechanism 216.

FIG. 2C depicts a second embodiment of the prior art detonator of FIG. 2A that also functions by creating an electrical arc within a stream of a detonable gas mixture. As shown in FIG. 2C, a gas mixture 106 of a combustible gas and oxidizer in the correct detonable ratio is passed into a detonation tube 100 via fill point 208 of detonator 114. When the tube is substantially full, high voltage wire 108 is triggered at high voltage pulse input 214 to cause a spark 212 to occur across bare wires 210 and to pass through the gas mixture 106 flowing into the detonation tube 100 to initiate detonation of the gas in the detonation tube 100. In this variation the spark is initiated within detonator 114 and then it is quickly swept along the two diverging conductors into the detonation tube 100 by the flowing gas, the length of the spark increasing as it travels into the detonation tube 100. When a spark is initiated in a small gap it creates a stable low impedance zone that is capable of conducting the same voltage electricity across a much larger gap. Alternatively, the wires 210 may be parallel but bent slightly closer together to ensure that the spark starts inside detonator 114.

FIGS. 3A and 3B provide end and side views of the exemplary prior art overpressure wave generator 11 of FIG. 2A. As shown in FIGS. 3A and 3B, detonator 114 comprises insulating cylinder 302 surrounding detonator tube 304. Electrodes 306 are inserted from the sides of insulating cylinder 302 and are connected to high voltage wire 108. The detonator tube 304 is connected to fuel-oxidant mixture supply 105 (shown in FIG. 3B) at fill point 208 and to detonation tube 100 at its opposite open end 310. As shown in FIG. 3B, a gas mixture 106 is passed into the detonation tube 304 via fill point 208 of detonator 114 and then out its open end 310 into detonation tube 100. When detonation tube 100 is essentially full, high voltage wire 108 is triggered to cause a spark 212 to occur across electrodes 306 thereby igniting the gas mixture 106 and creating a detonation impulse at the point of ignition that propagates through the gas mixture 106 flowing into detonator tube 304 from the ignition point to the open end 310 of detonator 114 to initiate detonation of the gas in detonation tube 100. Also shown in FIG. 3B is a Shchelkin spiral 308 just inside the closed end of detonation tube 100. The Shchelkin spiral 308 is well known in the art as a DDT enhancement device. In one exemplary embodiment, the Shchelkin spiral 308 has 10 turns, is 7″ long, and is constructed using #4 copper wire that is tightly wound against the inside of the detonation tube 100 at its base (closed end).

FIG. 3C depicts an embodiment of the prior art detonator of FIG. 2A that is the same as shown in FIGS. 3A and 3B but which also includes a check valve 312 used to control the flow of a supplied fuel-oxidant mixture where the check valve 312 is placed in front of the spark 212, also referred to herein as the ignition point.

FIG. 3D depicts an exemplary embodiment of the prior art detonator of FIG. 2A that is the same as shown in FIG. 3C except the check valve 312 is placed after ignition point 212.

FIG. 3E depicts an exemplary check valve 312 that can be used with the exemplary embodiments of the prior art detonator of FIG. 2A shown in FIGS. 3C and 3D. Check valve comprises a ball 314 held against opening 316 by spring 318. When appropriate pressure is supplied to ball 314 it compresses spring 318 allowing fuel-oxidant mixture 106 through opening 316. Other types of valves can also be used in accordance with the present invention.

### SUMMARY OF THE INVENTION

Briefly, the present invention is an improved system and method for ignition of a gaseous or dispersive fuel-oxidant mixture involving a device that produces zero reaction time combustion. In one exemplary embodiment, a device for zero reaction time combustion includes a tube having a fill point and an open end where the tube is supplied a gaseous or dispersive fuel-oxidant mixture at the fill point. The gaseous or dispersive fuel-oxidant mixture flows through the tube and an igniter placed at an ignition point within the tube. The igniter continuously ignites the gaseous or dispersive fuel-oxidant mixture while it is flowing through the tube thereby continuously producing zero reaction time combustion at the ignition point that produces exhaust and a continuous pressure, where the exhaust travels from the ignition point to the open end of the tube.

The device may include a valve that is located inside the tube, where the valve can be a check valve.

In another exemplary embodiment, a system for igniting a gaseous or dispersive fuel-oxidant mixture includes a tube having a fill point, an open end and an igniter at an ignition point within the tube and a fuel supply for supplying a gaseous or dispersive fuel-oxidant mixture to the fill point of the tube. The gaseous or dispersive fuel-oxidant mixture flows through the tube and the igniter continuously ignites the gaseous or dispersive fuel-oxidant mixture while said gaseous or dispersive fuel-oxidant mixture is flowing through the tube thereby continuously producing a zero reaction time combustion at the ignition point that produces exhaust and a continuous pressure, where the exhaust travels from the ignition point to the open end of the tube.

The system may include a valve that is located inside the tube, where the valve can be a check valve. The valve can be located before the ignition point.

A mass ratio of fuel versus oxidant and a flow rate of said gaseous or dispersed fuel-oxidant mixture can be selected based on a length and a diameter of said tube.

The continuous pressure can be used to supply thrust to an airplane or a rocket, where an amplitude of the zero reaction time combustion can be used for steering the thrust.

The system may include a control mechanism for controlling the zero reaction time combustion.

In a further exemplary embodiment, a system for igniting a gaseous or dispersive fuel-oxidant mixture includes a device for zero reaction time combustion. The device for zero reaction time combustion includes a tube having a fill point and an open end and includes an igniter placed at an ignition point within the tube. The system also includes a fuel-oxidant mixture supply that supplies a gaseous or dispersive fuel-oxidant mixture to the fill point of the tube, which flows through the tube. The igniter continuously ignites the gaseous or dispersive fuel-oxidant mixture while the gaseous or dispersive fuel-oxidant mixture is flowing through the tube thereby continuously producing zero reaction time combustion at the ignition point that produces exhaust and a continuous pressure, where the exhaust travels from the ignition point to the open end of the tube.

The system may include a valve that is located inside the tube, where the valve can be a check valve.

A mass ratio of fuel versus oxidant and a flow rate of said gaseous or dispersed fuel-oxidant mixture can be selected based on a length and a diameter of said tube.

The continuous pressure can be used to supply thrust to an airplane or a rocket, where an amplitude of the zero reaction time combustion can be used for steering the thrust.

The system may include a control mechanism for controlling the zero reaction time combustion, where the control mechanism may include a trigger mechanism or a control processor.

The igniter may be a high voltage pulse source, a triggered spark gap source, or a laser.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates an exemplary prior art detonation tube having separate fuel and oxidizer supplies and a spark plug that ignites the fuel-oxidant mixture at the closed end of the tube after the tube has been filled as part of a deflagration to detonation transition process;

FIG. 1B illustrates a second exemplary prior art detonation tube having a fuel-oxidant mixture supply and a spark plug that ignites the fuel-oxidant mixture at the closed end of the tube after the tube has been filled as part of a deflagration to detonation transition process;

FIG. 2A illustrates an exemplary prior art detonation tube having a detonator that receives a fuel-oxidant mixture from a fuel-oxidant mixture supply and ignites the fuel-oxidant mixture as it is flowing into the tube as part of an instantaneous detonation process;

FIG. 2B depicts a first embodiment of the prior art detonator of FIG. 2A that functions by creating an electrical arc within a stream of a gas mixture;

FIG. 2C depicts a second embodiment of the prior art detonator of FIG. 2A that is similar to that depicted in FIG. 2B except it includes two conductors that diverge into the main tube causing the length of the spark to increase as it travels into the main detonation tube;

FIG. 3A depicts an end view of another embodiment of the prior art overpressure wave generator of FIG. 2A.

FIG. 3B depicts a side view of the prior art overpressure wave generator of FIG. 3A.

FIG. 3C depicts an exemplary embodiment of the prior art detonator of FIG. 2A including a check valve used to control the flow of a supplied fuel-oxidant mixture where the check valve is placed in front of the ignition point in the detonator tube;

FIG. 3D depicts an exemplary embodiment of the prior art detonator of FIG. 2A including a check valve used to control the flow of a supplied fuel-oxidant mixture where the check valve is place after of the ignition point in the detonator tube;

FIG. 3E depicts an exemplary check valve that can be used with the exemplary embodiments of the prior art detonator of FIG. 2A shown in FIGS. 3C and 3D;

FIG. 4A depicts the distance that the generated detonation wave travels from the point of ignition to the end of the exemplary prior art detonator of FIG. 3B;

FIG. 4B depicts an embodiment of the detonator of the present invention where, instead of a detonation wave, exhaust generated by a zero reaction time combustion process travels from the point of ignition to the end of a detonator tube; and

FIG. 5 depicts an exemplary method of the present invention.

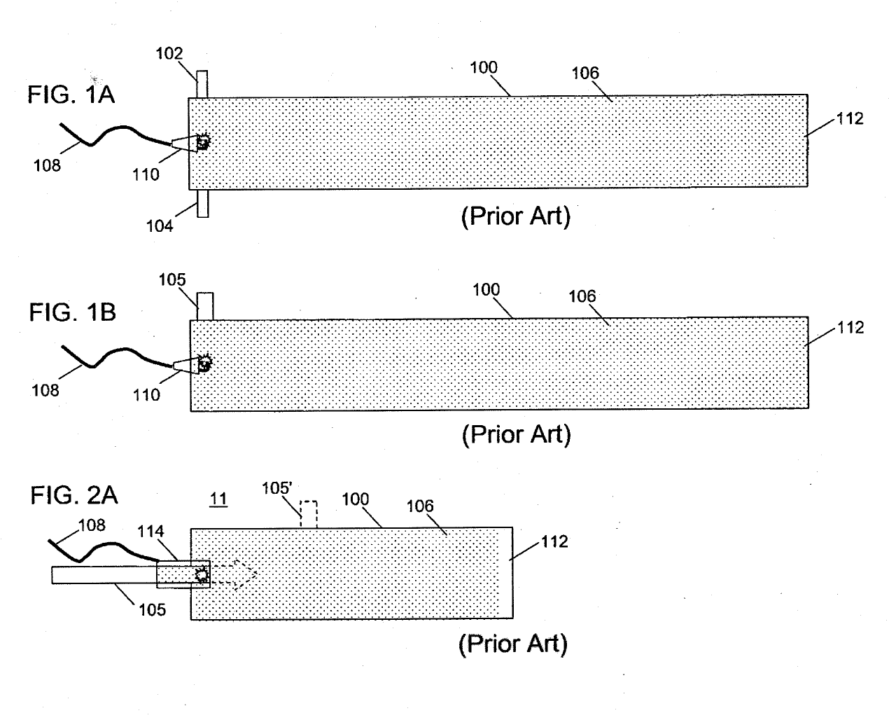

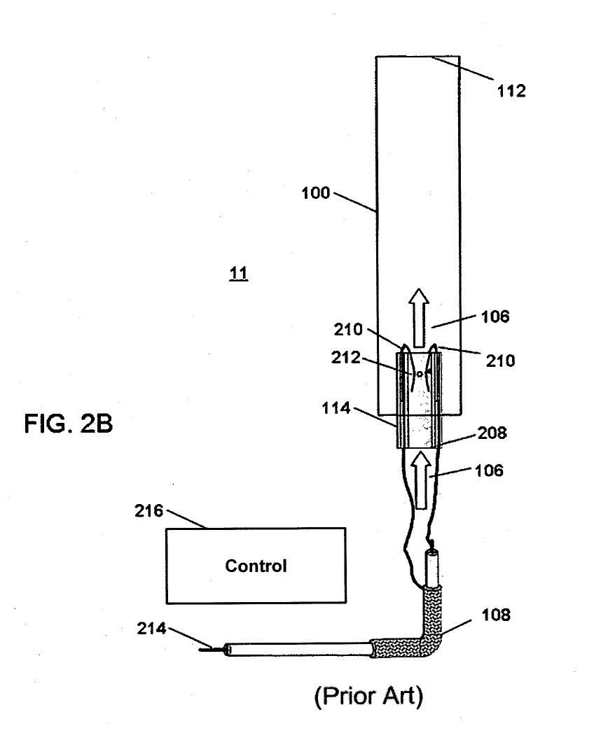

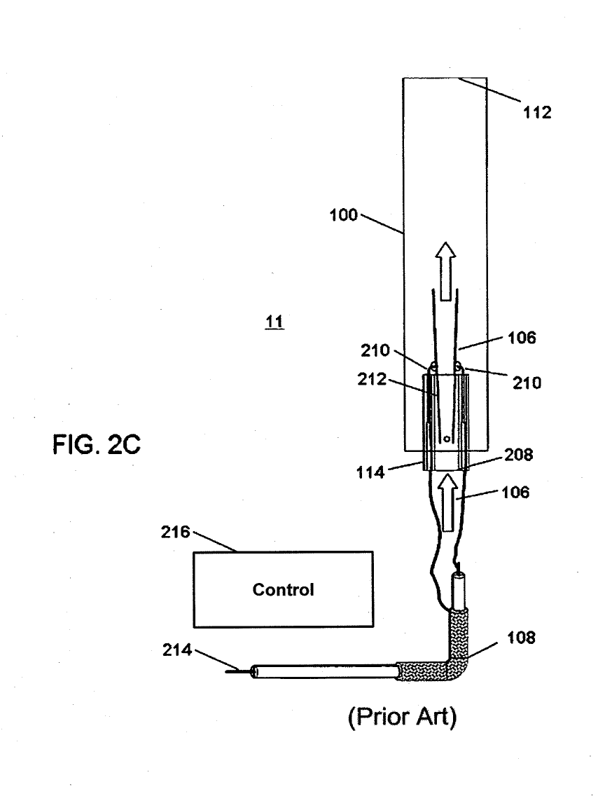

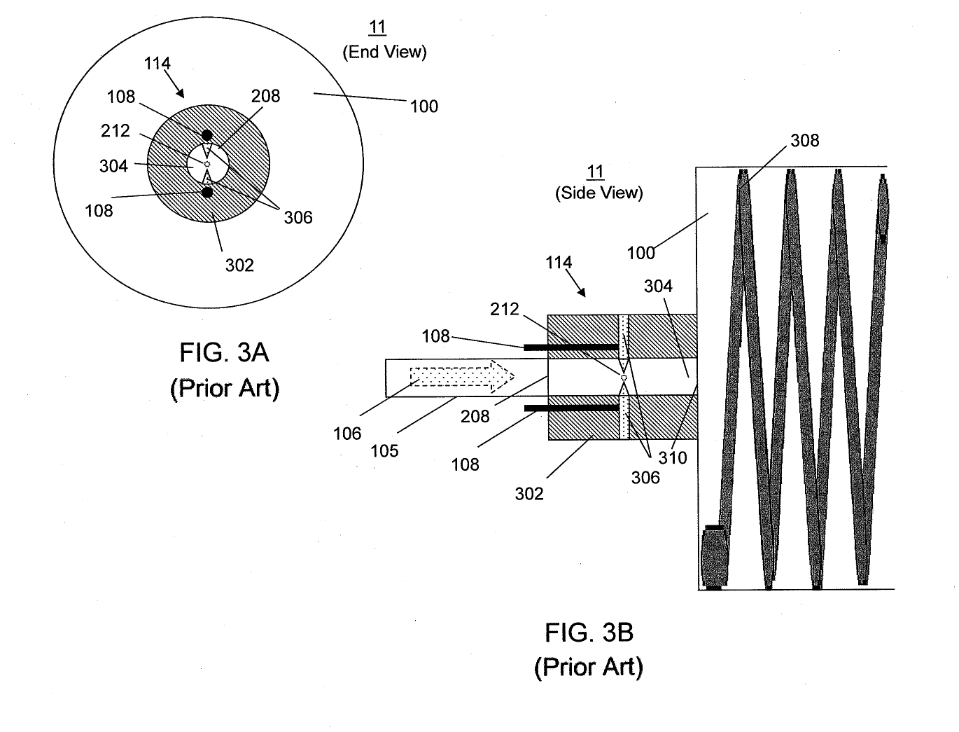

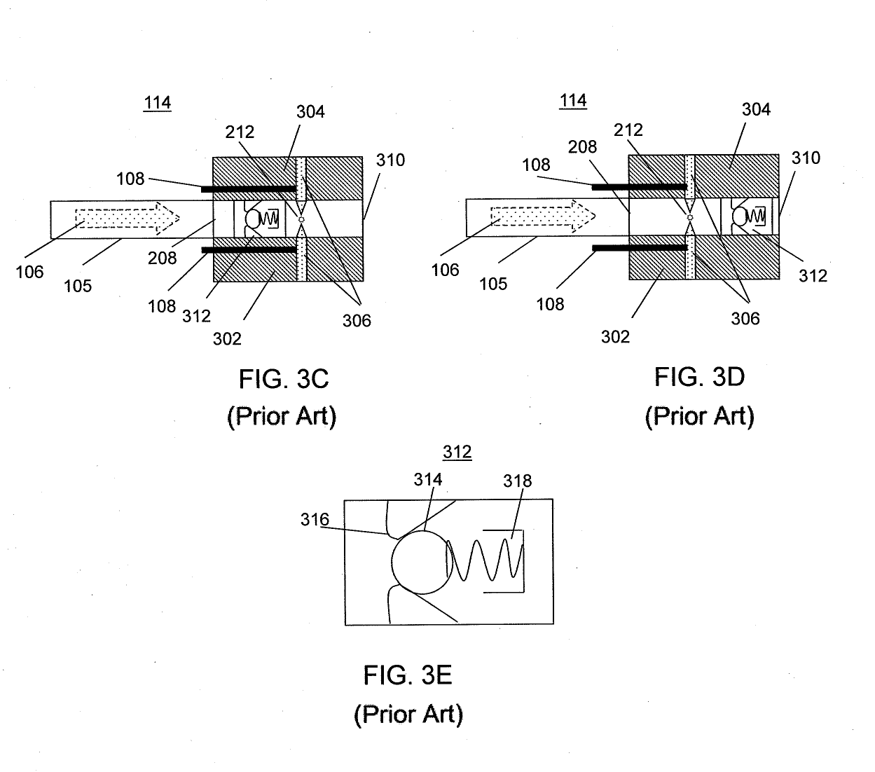

### DETAILED DESCRIPTION OF THE INVENTION

The present invention will now be described more fully in detail with reference to the accompanying drawings, in which the exemplary embodiments of the invention are shown. This invention should not, however, be construed as limited to the embodiments set forth herein; rather, they are provided so that this disclosure will be thorough and complete and will fully convey the scope of the invention to those skilled in the art. Like numbers refer to like elements throughout.

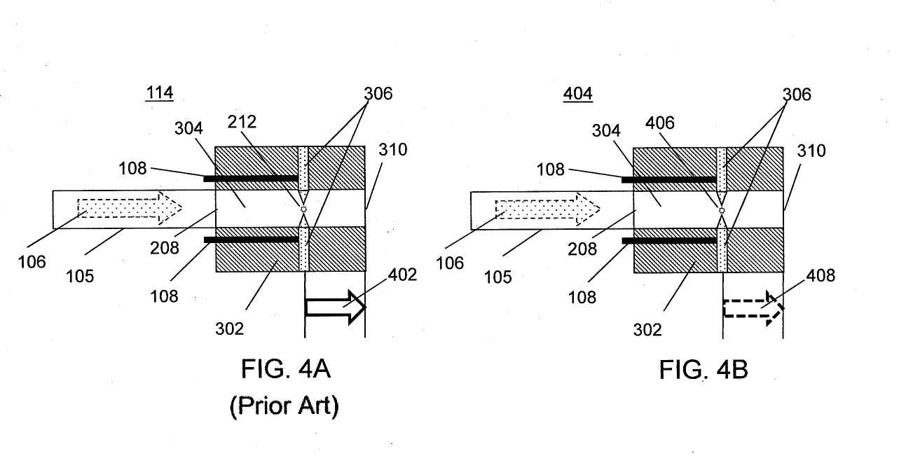

The present invention is a system and method for zero reaction time combustion where continuous ignition of a gaseous or dispersive fuel-oxidant mixture flowing within a tubular structure generates a constant pressure or thrust. The zero reaction time combustion process involves continuously igniting a flowing (or moving) stream of gas and oxidizer mixture that is filling a tube. To initiate the process, a desired ratio and flow rate of the flowing stream of gas and oxidizer mixture is supplied to the tubular structure. When the tube is substantially full, a spark is initiated within the flowing gas at an ignition point in the tube. Once initiated the supply of fuel and the ignition of that fuel is maintained in a zero reaction time combustion process. The zero reaction time combustion process could be described as a continuous detonation process because it is somewhat analogous to having essentially reduced the timing between impulse detonations to zero. But there is no propagation of a detonation wave through the tube as would be the case with the prior art instantaneous detonation process such as is depicted in FIG. 4A. Instead the continuous ignition of the flowing fuel produces exhaust and a continuous pressure or thrust such as depicted in FIG. 4B. Thus, even though the zero reaction time combustion process continuously produces a supersonic exothermic exhaust, it is actually unlike what has previously been called a detonation process since detonation only occurs at the ignition point and doesn't propagate down the tube (except for the initial detonation when the process is initiated).

Referring to FIG. 4A, a detonator 114 comprises insulating cylinder 302 surrounding a detonator tube 304. Electrodes 306 are inserted from the sides of insulating cylinder 302 and are connected to high voltage wire 108. The detonator tube 304 is connected to fuel-oxidant mixture supply 105 at fill point 208 and has an opposite open end 310. The gas mixture 106 is passed into the detonation tube 304 via fill point 208 of detonator 114. A high voltage wire 108 is triggered to cause a spark 212 to occur across electrodes 306 thereby igniting the flowing gas mixture 106 and creating a detonation impulse at the point of ignition that propagates from the ignition point to the open end 310 of the detonator tube 304 as represented by the bold arrow 402.

Referring to FIG. 4B, a zero reaction time combustion device 404 comprises insulating cylinder 302 surrounding a detonator tube 304, which may be referred to as a tube. Electrodes 306 are inserted from the sides of insulating cylinder 302 and are connected to high voltage wire 108. The tube 304 is connected to fuel-oxidant mixture supply 105 at fill point 208 and has an opposite open end 310. The gas mixture 106 is passed into the tube 304 via fill point 208 of zero reaction time combustion device 404. A high voltage wire 108 is triggered to cause a spark 212 to continuously occur across electrodes 306 thereby continuously igniting the flowing gas mixture 106 and creating a zero reaction time combustion at the point of ignition that produces exhaust and a continuous pressure (or thrust). The exhaust travels from the ignition point to the open end 310 of the tube 304 as represented by the dashed bold arrow 408.

A control system can modulate the amplitude of the zero reaction time combustion process by varying at least one the of the gas to oxidizer ratio or the flow rate of the flowing stream of gas and oxidizer mixture, and the zero reaction time combustion process can be ended by stopping at least one of the supplying of the fuel or the igniting of the fuel.

One embodiment of the present invention comprises a plurality of detonators configured for constant pressure generation using a zero reaction time combustion process. Associated with the plurality of detonators are a plurality of spark initiators, where a single spark initiator may initiate sparks in multiple detonators and multiple spark initiators may initiate sparks in a given detonator of the plurality of detonators.

A spark initiator may be a high voltage source. As an alternative to the high voltage source a spark gap approach can be used as a spark initiator. Another alternative for a spark initiator is a laser.

A control processor may be used to control variable parameters of the fuel-oxidant mixture supply subsystem or such parameters may be fixed. The control processor also controls the starting and stopping of the zero reaction time combustion process.

The fuel-oxidant mixture supply subsystem maintains a desired mass ratio of fuel versus oxidant of the fuel-oxidant mixture and a desired flow rate of the fuel-oxidant mixture. Desired fuel versus oxidant ratio and flow rate can be selected to achieve desired detonation characteristics that depend on length and diameter characteristics of the detonator. For example, one embodiment uses a propane-air fuel-oxidant mixture, a mass ratio of 5.5 and a flow rate of 50 liters/minute for a detonator having a length of 1″ and a ¼″ diameter and made of Teflon.

Commercially available mass flow control valve technology can be used to control the mass ratio of fuel versus oxidant of the fuel-oxidant mixture and the flow rate of the fuel-oxidant mixture. Alternatively, commercially available technology can be used to measure the mass flow of oxidant into a fuel-oxidant mixture mixing apparatus and the precise oxidant mass flow measurement can be used to control a mass flow control valve to regulate the mass flow of the fuel needed to achieve a desired mass ratio of fuel versus oxidant of the fuel-oxidant mixture.

In accordance with one embodiment of the invention, a magnetic field is provided to accelerate the exhaust produced by the zero reaction time combustion process.

One or more detonators of the present invention can be used to supply thrust in applications such as airplanes and rockets.

When an array of detonators is used, the amplitude (or strength) of thrust provided by detonators on one side of the array of detonators can varied (e.g., lowered or increased) to provide a torque to the thrust being produced by the array of detonators as a form of vectorization for steering the thrust.

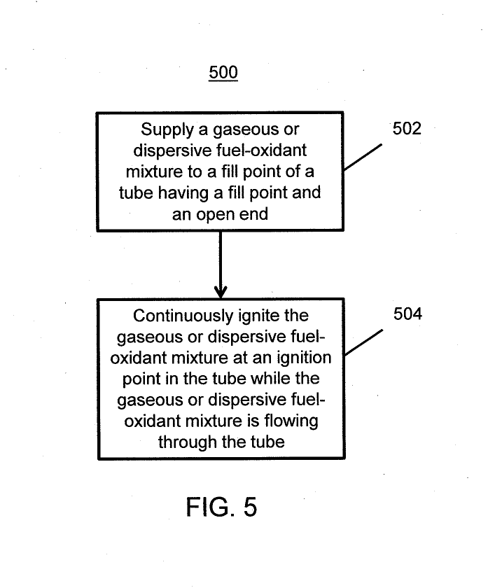

FIG. 5 depicts an exemplary method 500 for zero reaction time combustion in accordance with another embodiment of the invention. Referring to FIG. 5, the method 500 includes a first step 502 which is to supply a gaseous or dispersive fuel-oxidant mixture to a fill point of a tube having a fill point and an open end. The method 500 also includes a second step 504 which is to continuously ignite the gaseous or dispersive fuel-oxidant mixture at an ignition point in the tube while the gaseous or dispersive fuel-oxidant mixture is flowing through the tube.

While particular embodiments and several exemplary applications (or implementations) of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements which embody the spirit and scope of the present invention.

1. A device for zero reaction time combustion, comprising:
a tube, said tube having a fill point and an open end, said fill point being supplied a gaseous or dispersive fuel-oxidant mixture that flows through said tube; and
an igniter, said igniter being placed at an ignition point within said tube, said igniter continuously igniting said gaseous or dispersive fuel-oxidant mixture while said gaseous or dispersive fuel-oxidant mixture is flowing through said tube thereby continuously producing a zero reaction time combustion at said ignition point that produces exhaust and a continuous pressure, said exhaust traveling from said ignition point to said open end.

2. The device of claim 1, further comprising:
a valve, said valve located inside said tube.

3. The device of claim 2, wherein said valve is a check valve.

4. A system for igniting a gaseous or dispersive fuel-oxidant mixture, comprising:
a tube having a fill point, an open end and an igniter at an ignition point within the tube; and
a fuel supply for supplying a gaseous or dispersive fuel-oxidant mixture to said fill point of said tube, said gaseous or dispersive fuel-oxidant mixture flowing through said tube, said igniter continuously igniting said gaseous or dispersive fuel-oxidant mixture while said gaseous or dispersive fuel-oxidant mixture is flowing through said tube thereby continuously producing a zero reaction time combustion at said ignition point that produces exhaust and a continuous pressure, said exhaust traveling from said ignition point to said open end.

5. The system of claim 4, further:
a valve, said valve located inside said tube

6. The system of claim 5, wherein said valve is a check valve.

7. The system of claim 6, wherein said valve is located before said ignition point.

8. The system of claim 4, wherein a mass ratio of fuel versus oxidant and a flow rate of said gaseous or dispersed fuel-oxidant mixture is selected based on a length and a diameter of said tube.

9. The system of claim 4, wherein said continuous pressure supplies thrust to one of an airplane or a rocket.

10. The system of claim 9, wherein an amplitude of said zero reaction time combustion is used for steering said thrust.

11. The system of claim 4, further comprising:
a control mechanism for controlling the zero reaction time combustion.

12. A system for igniting a gaseous or dispersive fuel-oxidant mixture, comprising:
a device for zero reaction time combustion, comprising:
a tube, said tube having a fill point and an open end; and
an igniter, said igniter being placed at an ignition point within said tube; and
a fuel-oxidant mixture supply that supplies a gaseous or dispersive fuel-oxidant mixture to said fill point of said tube, said gaseous or dispersive fuel-oxidant mixture flowing through said tube, said igniter continuously igniting said gaseous or dispersive fuel-oxidant mixture while said gaseous or dispersive fuel-oxidant mixture is flowing through said tube thereby continuously producing a zero reaction time combustion at said ignition point that produces exhaust and a continuous pressure, said exhaust traveling from said ignition point to said open end.

13. The system of claim 12, said device for zero reaction time combustion further comprising:
a valve, said valve located inside said tube.

14. The system of claim 13, wherein said valve is a check valve.

15. The system of claim 12, wherein a mass ratio of fuel versus oxidant and a flow rate of said gaseous or dispersed fuel-oxidant mixture is selected based on a length and a diameter of said tube.

16. The system of claim 12, wherein said continuous pressure supplies thrust to one of an airplane or a rocket.

17. The system of claim 16, wherein an amplitude of said zero reaction time combustion is used for steering said thrust.

18. The system of claim 12, further comprising:
a control mechanism for controlling the zero reaction time combustion.

19. The system of claim 18, wherein said control mechanism comprises one of a trigger mechanism or a control processor.

20. The system of claim 12, wherein said igniter comprises one of a high voltage pulse source, a triggered spark gap source, or a laser.
